(19) United States
(12) Patent Application Publication
(10) Pub. No.: US 2011/0111771 A1
(43) Pub. Date: May 12, 2011

(54) Method and System for Location Update in Mobile Network

(75) Inventor: Phillip Barber, McKinney, TX (US)

(73) Assignee: FutureWei Technologies, Inc., Plano, TX (US)

(21) Appl. No.: 12/939,876

(22) Filed: Nov. 4, 2010

Related U.S. Application Data
(60) Provisional application No. 61/258,886, filed on Nov. 6, 2009.

(51) Int. Cl. H04W 4/02

(52) U.S. Cl. 455/456.1

(57) ABSTRACT

A system and method for performing a location update is disclosed. A preferred embodiment comprises transmitting a first location update transmission and receiving back a location update transmission response that is not simply an indication of success or failure. In an embodiment a redirection message is included in order to redirect the mobile station to another base station instead of simply telling the mobile station that the location update transmission has failed.

This application claims the benefit of U.S. Provisional Application No. 61/258,886, filed on Nov. 6, 2009, entitled “Location Update Redirection for Idle Mode Operation in Mobile Networks,” which application is hereby incorporated herein by reference.

### TECHNICAL FIELD

The present invention relates generally to a system and method for wireless communication, and more particularly to a system and method for a location update redirection in a wireless network.

### BACKGROUND

Generally, in a wireless network having a base station and a mobile station, the mobile station may occasionally enter into an idle mode in order to preserve power and resources. While in this idle mode, the mobile station may transmit a “Location Update in Idle Mode” to the base station in order to periodically notify the base station of its location, thereby helping the base station transmit to the mobile station when the base station receives data destined for the mobile station. When the base station receives a “Location Update in Idle Mode” transmission, the base station may send either an indication of success, or, if the base station for some reason is unable or unwilling to continue to transmit to the mobile station (e.g., if there has been a significant degradation in the link quality), the base station may transit an indication of failure. This indication of failure, when received by the mobile station, may cause the mobile station to perform a full Network Re-Entry from Idle Mode operation in order to initiate contact with another base station.

However, there are times in which the base station may be able to communicate with the mobile station, but for some reason would prefer the mobile station to communicate with another base station, such as for load balancing purposes. Because the “Location Update in Idle Mode” response transmits an indication of success or failure and does not permit for mobile station redirection to an alternate base station to perform the “Location Update in Idle Mode” event without transmittal of the failure indication code, the base station is compelled to indicate failure and the mobile station is compelled to conduct the full Network Re-Entry from Idle Mode operation in order to recover. The result is waste of air interface resources and event latency when the mobile station is forced to perform the full Network Re-Entry from Idle Mode operation.

### SUMMARY OF THE INVENTION

These and other problems are generally solved or circumvented, and technical advantages are generally achieved, by preferred embodiments of the present invention which provide for a wireless communication network.

In accordance with a preferred embodiment of the present invention, a method for wireless communication comprises receiving a location update transmission at a wireless base station and transmitting a location update response from the wireless base station. The location update response comprises a message, the message being other than success or failure.

In accordance with another preferred embodiment of the present invention, a method for wirelessly transmitting data comprises transmitting a location update transmission from a mobile station and receiving a location update transmission response at the mobile station, the location update transmission response comprising a message free from an indication of success or failure.

In accordance with yet another preferred embodiment of the present invention, a method for wirelessly transmitting data comprises transmitting a first location update transmission from a mobile station to a first base station and receiving a location update transmission response at the mobile station from the first base station, the location update transmission response comprising a redirect message that indicates a second base station. A second location update transmission is transmitted from the mobile station to the second base station.

In accordance with yet another preferred embodiment of the present invention, a wireless base station comprises a receiver configured to receive a location update transmission and a transmitter configured to transmit a location update transmission response. The location update transmission response comprises a message different from a success indication and different from a failure notification.

In accordance with yet another preferred embodiment of the present invention, a wireless mobile station comprises a transmitter configured to transmit a first location update transmission and a receiver configured to receive a first location update response. The first location update response comprises information indicative of a redirection.

An advantage of a preferred embodiment of the present invention is that a mobile station is not required to enter into a full Network Re-Entry from Idle Mode operation when the mobile station does not receive an indication of success after transmitting a location update. By avoiding the full Network Re-Entry from Idle Mode operation, resources and power may be conserved and provide a more efficient overall operation for the system, and mobile station location establishment is not delayed by lengthy full Network Re-Entry form Idle Mode operation thus avoiding impact to service interruptions that may impact timely delivery of data to/from the mobile station.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a first base station, a second base station, and a mobile station providing voice, data and/or other wireless communication services in accordance with an embodiment of the present invention;

FIG. 2 illustrates the transmission of a second location update transmission to a second base station in accordance with an embodiment of the present invention; and

FIG. 3 illustrates a structural diagram of the base station and the mobile station in accordance with an embodiment of the present invention.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a wireless network communication system. The invention may also be applied, however, to other communication systems.

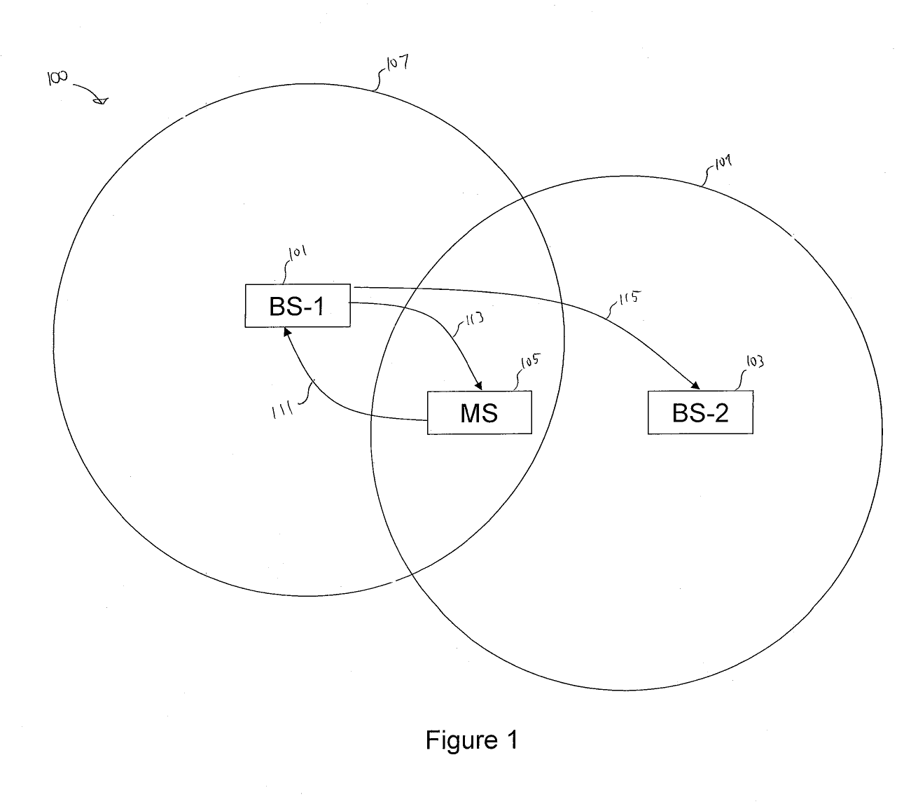

FIG. 1 shows a wireless communication network 100 that comprises a first base station (BS-1) 101, a second base station (BS-2) 103, and a mobile station (MS) 105 providing voice, data and/or other wireless communication services. The BS-1 101, which may also be referred to by other names such as access network (AN), access point (AP), Node-B, etc., preferably transmits downlink (DL) information to the MS 105 while also receiving uplink (UL) information from the MS 105.

The BS-1 101 preferably has a corresponding coverage area 107. This coverage area 107 generally represents the range of the BS-1 101 to adequately transmit data to the MS 105 while also being able to adequately receive data transmitted from the MS 105. Further, while the coverage area 107 is shown as a definitive line in FIG. 1 for convenience, one of ordinary skill in the art will realize that the coverage area 107 varies depending upon a number of factors including the MS 105, the power of the BS-1 101, local terrain, intervening buildings, and the like.

Preferably, the wireless communications network 100 includes, but is not limited to, an orthogonal frequency division multiple access (OFDMA) network such as an Evolved Universal Terrestrial Radio Access (E-UTRA) network, an Ultra Mobile Broadband (UMB) network, or an IEEE 802.16 network. However, as one of ordinary skill in the art will recognize, the listed networks are merely illustrative and are not meant to be exclusive. Any suitable multiple access scheme network, such as a frequency division multiplex access (FDMA) network wherein time-frequency resources are divided into frequency intervals over a certain time interval, a time division multiplex access (TDMA) network wherein time-frequency resources are divided into time intervals over a certain frequency interval, a code division multiplex access (CDMA) network wherein resources are divided into orthogonal or pseudo-orthogonal codes over a certain time-frequency interval, or the like may alternatively be used.

The MS 105 may comprise any device that desires to communicate, either directly or indirectly, with the BS-1 101. The MS 105 may include mobile phones, personal data assistants (PDAs), notebook computers, other computers that have a wireless connection with the BS-1 101, or the like. Additionally, the MS 105 may also be any other suitable device used to transfer data between itself and the BS-1 101 (including through, e.g., a transceiver).

The MS 105 preferably utilizes release 10 of the 3GPP wireless communication specification (3GPP Rel-10) or later versions of the 3GPP wireless communication specification. However, the present embodiments are not limited to this wireless communication specification. For example, the Worldwide Interoperability for Microwave Access (WiMAX), Evolution-Data Optimized EV-DO, or Universal Mobile Telecommunications System (UMTS) communication standards may alternatively be utilized. These standards and all other suitable standards are fully intended to be included within the scope of the present embodiments. Additionally, the present embodiments may be modified as described more fully below to be backwards compatible with previous versions of the 3GPP specification

The BS-2 103 may be similar to the BS-1 101. For example, the BS-2 103 may be an AN, an AP, a Node-B, etc. which preferably transmits downlink (DL) information to the MS 105 while also receiving uplink (UL) information from the MS 105. Additionally, the BS-2 103 may be a closed network access point or an open network access point that is able and willing to access the MS 105 accessing it.

Additionally, the BS-2 103 has a corresponding second coverage area 109. Similar to the first coverage area 107, the second coverage area 109 represents a range within which the BS-2 103 can adequately transmit data to the MS 105 while also being able to adequately receive transmissions from the MS 105. Additionally, as shown in FIG. 1, the first coverage area 107 and the second coverage area 109 may have some overlap in order to accommodate handoffs of the MS 105 from, e.g., the BS-1 101 to the BS-2 103.

FIG. 1 additionally illustrates a location update transmission 111 from the MS 105 to the BS-1 101. This location update transmission 111 may notify the BS-1 101 of the MS's 105 location, the paging parameters, location registration information, and other characteristics so that the BS-1 101 can efficiently transmit data that the BS-1 101 receives that is destined for the MS 105. The location update transmission 111 may be sent from the MS 105 either after a pre-defined time has expired or else if the MS 105 receives a paging message from the BS-1 101.

Additionally, the location update transmission 111 may be a “Location Update in Idle Mode,” in which the MS 105 transmits the location update transmission 111 while the MS 105 is in an idle mode. This idle mode allows the MS 105 to reduce its operations in order to conserve power and resources. However, because the MS 105 will still receive transmissions from the BS-1 101, the location update transmission 111 may still be sent in order to notify the BS-1 101 of the location of the MS 105 so that such transmissions may be sent to the MS 105.

After receiving the location update transmission 111 from the MS 105, the BS-1 101 may respond with a location update response transmission 113. The location update response transmission 113 may provide an indication of success or failure of the location update transmission 111 back to the MS 105. Upon receiving an indication of success, the MS 105 may continue in its idle mode. Conversely, upon receiving an indication of failure, the MS 105 may attempt a full Network Re-Entry from Idle Mode, in which the MS 105 attempts to find and register with another base station (e.g., BS-2 103) with which it can communicate.

Additionally, there may be situations in which a simple indication of success/failure is not appropriate. For example, there may be circumstances where the BS-1 101 may be able to successfully communicate with the MS 105 but may still wish to refuse the location update transmission 111 without indicating a complete failure. Such situations may occur when the BS-1 101 is restricting access or is a closed-group Femto base station to which the MS 105 does not have approved access (to which the MS 105 may not be aware of the “closed” nature at the time of the location update transmission 111). In addition to simple restricted access, these situations may also occur based upon a degradation in link quality, a load balancing determination to determine which of BS-1 101 or BS-2 103 is the most efficient base station, combinations of these, or the like.

In order to avoid the resources and power consumption that is required by a full Network Re-Entry from Idle Mode, the location update response transmission 113 may provide an alternate response to the location update transmission 111 than a simple indication of success/failure. With the addition of other types of responses that may be sent in the location update response transmission 113, the MS 105 may not be forced into the full Network Re-Entry from Idle Mode process. As such, all of the resources required by the full Network Re-Entry from Idle Mode process, both in the MS 105 as well as the air interface and network resources, may be reduced or eliminated.

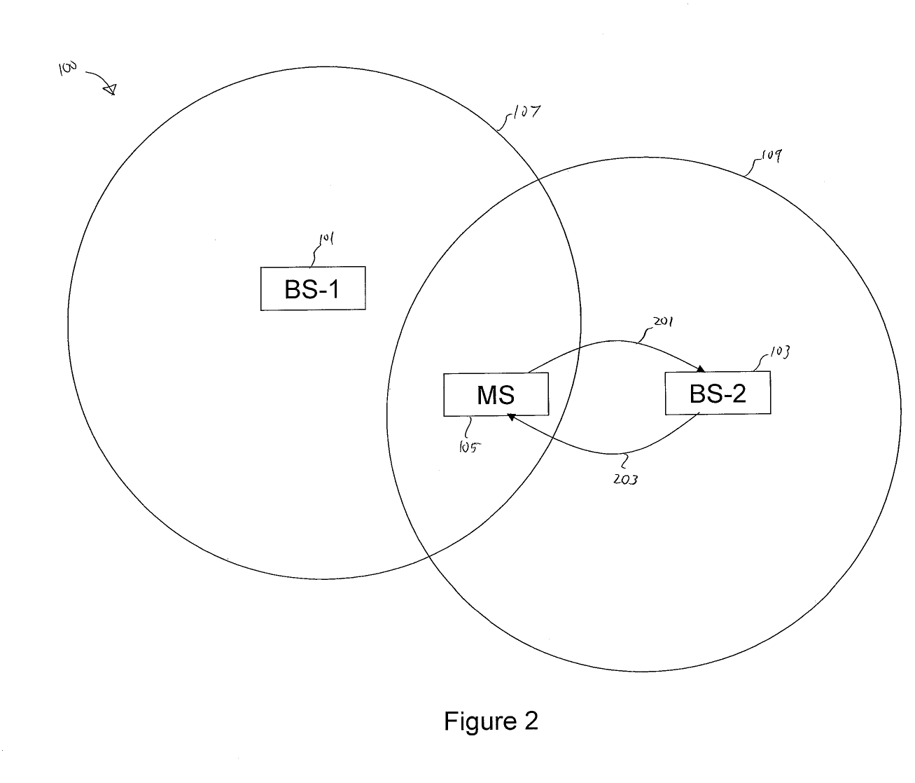

As one example only, the location update transmission response 113 may include a redirection message that will enable the MS 105 to attempt the location update transmission 111 at another Base Station (discussed further below with respect to FIG. 2). Such a redirection message may provide specific information such as center frequency, offset frequency, frequency override, preamble index, channel bandwidth, frequency duplexing type, base station identifier, combinations of these, and the like that may be useful in redirecting the MS 105 to another base station, such as BS-2 103. Such information may be used to direct the MS 105 to another base station, such as the BS-2 103, that will provide a successful location update to the MS 105. Such information may be obtained by the BS-1 101 from the BS-2 103 through, e.g., a wired connection or other means of communication before the redirection message is sent to the MS 105.

Additionally, the BS-1 101 may also transmit a base station update message 115 to the BS-2 103. The base station update message 115 may be transmitted either wirelessly or over a wired connection between the BS-1 101 and the BS-2 105, and may be sent to inform the BS-2 105 about, e.g., the location update response transmission 113 which contains the redirection message redirecting the MS 105 to the BS-2 103. By sending the base station update message 115 to the BS-2 103, the BS-2 103 may prepare for transmissions from the MS 105 prior to actually receiving a transmission from the MS 105.

FIG. 2 illustrates that once the MS 105 has received the location update transmission response 113 that includes a redirection message, the MS 105 may transmit a second location update transmission 201 to the BS-2 103. The second location update transmission response 201 may be similar to the first location update transmission 109 sent to the BS-1 101 and may, for example, include the MS's 105 location, the paging parameters, location registration information, and other characteristics that the BS-2 103 may desire. Additionally, similar to the first location update transmission response 113, the second location update transmission response 201 may also be a “Location Update in Idle Mode” transmission sent while the MS 105 remains in an idle state.

After the BS-2 103 has received the second location update transmission 201 from the MS 105, the BS-2 103 may transmit a second location update transmission response 203 back to the MS 105. The second location update transmission response 203 may include an indication of success, and indication of failure, or another indication, such as another redirection indication as discussed above with respect to FIG. 1 that would redirect the MS 105 to yet another base station (not shown).

By providing more than simply a success/failure response to the MS 105 when the MS 105 initiates a location update transmission 111, the MS 105 does not necessarily need to initiate a full Network Re-Entry from Idle Mode process in order to re-establish communication with a base station. By using a much less resource intensive procedure, such as by providing a redirection message, the MS 105 may use less power, resource, and air and network resources, thereby leading to more efficient operation for the network as a whole.

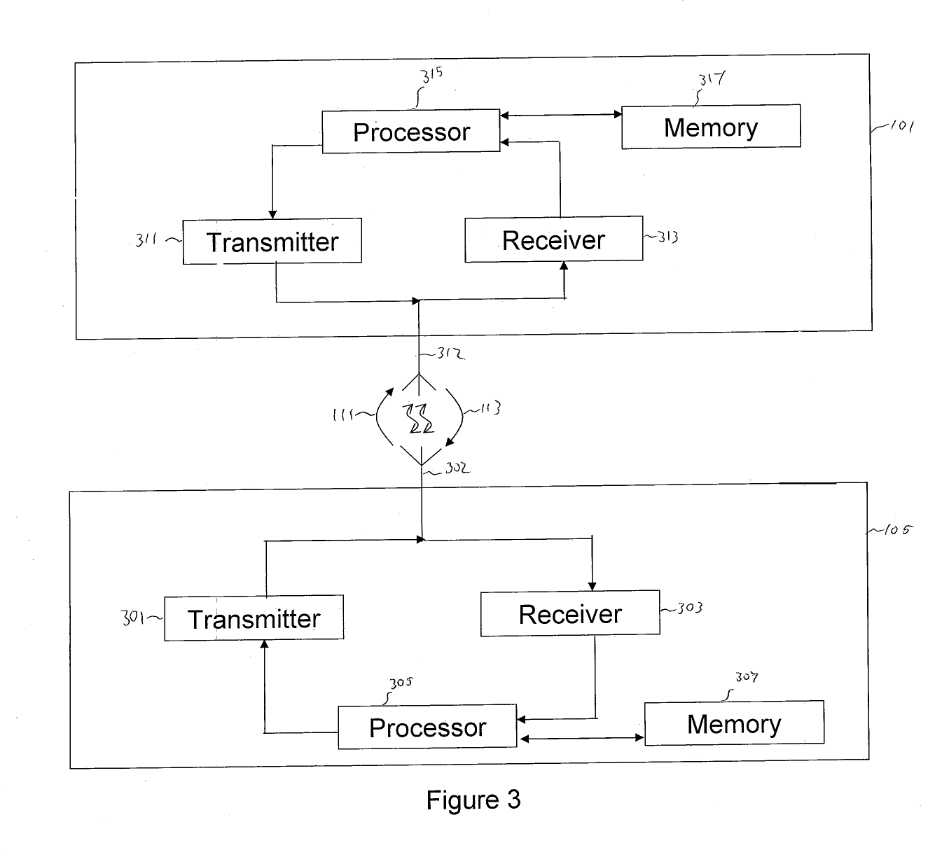

FIG. 3 shows a structural diagram of one embodiment of the BS-1 101 and the MS 105. The MS 105 may include a first transmitter 301 configured to transmit the location update transmission 111 and the second location update transmission 201 (not explicitly shown in FIG. 3) through a first antenna 302. The MS 105 may also include a first receiver 303 that is configured to receive transmissions such as the location update response transmission 113 and forward them to a first processor 305. The first processor 305, along with an associated first memory 307 may be used to process and/or store information received from the receiver (e.g., the location update response transmission 113) and prepare a response to the information received, such as determining the contents of, e.g., the location update response transmission 113 and an appropriate response. Additionally, the first processor 305 may prepare and forward a message, such as the second location update transmission 201 to the first transmitter 301 for transmission through the first antennae 302.

The first transmitter 301, the first receiver 303, the first processor 305 and the first memory 307 may all be physically separate structures as illustrated in FIG. 3. Alternatively, however, some or all of these structures may be consolidated onto a single chip in order to conserve space and other resources.

The BS-1 101 may contain a second receiver 313 in order to receive, e.g., the location update transmission 111 from the MS 105. The second receiver 313 may forward the location update transmission 111 to the second processor 315 and its associated second memory 317, which may analyze the location update transmission 111 and determine an appropriate response. For example, the second processor 315 may receive the location update transmission 111 and perform a load balancing determination to determine whether or not to direct MS 105 to another base station, such as BS-2 303. Once an appropriate response has been determined, the second processor 315 may forward the response, such as the location update response transmission 113 to the second transmitter 311 to transmit, e.g., the location update response transmission 113 back to the MS 105 through a second antenna 312.

Similar to the MS 105, the second transmitter 301, the second receiver 313, the second processor 315, and the second memory 317 may all be physically separate components of the BS-1 101 as illustrated in FIG. 3. Alternatively, however, some or all of these structures may be consolidated onto a single chip in order to conserve space and other resources. Any combination of these components onto individual chips

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that the precise information within the location update transmission responses may be varied while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for wireless communication comprising:
receiving a location update transmission at a wireless base station; and
transmitting a location update response from the wireless base station, the location update response comprising a message, the message being other than success or failure.

2. The method of claim 1, wherein the location update response comprises a redirection message.

3. The method of claim 2, wherein the redirection message comprises a center frequency and an offset frequency.

4. The method of claim 2, wherein the redirection message comprises information regarding an available base station.

5. The method of claim 1, wherein the wireless base station is a Femto wireless base station.

6. The method of claim 5, wherein the wireless base station is a closed group Femto base station.

7. The method of claim 1, further comprising determining if the wireless base station is the most efficient base station for further transmissions based upon a load balancing determination.

8. A method for wirelessly transmitting data, the method comprising:
transmitting a first location update transmission from a mobile station; and
receiving a location update transmission response at the mobile station, the location update transmission response comprising a message free from an indication of success or failure.

9. The method of claim 8, wherein the location update transmission response comprises information on redirection.

10. The method of claim 9, wherein the information on redirection includes information on an available base station.

11. The method of claim 9, wherein the information on redirection comprises a center frequency and an offset frequency.

12. The method of claim 8, further comprising transmitting a second location update transmission from the mobile station in response to the location update transmission response.

13. The method of claim 12, wherein the second location update transmission is transmitted based on an identification in the location update transmission response.

14. The method of claim 12, wherein the second location update transmission is performed without entering into a Network Re-Entry from Idle Mode operation.

15. The method of claim 8, wherein the first location update transmission is transmitted during an idle mode.

16. A method for wirelessly transmitting data, the method comprising:
transmitting a first location update transmission from a mobile station to a first base station;
receiving a location update transmission response at the mobile station from the first base station, the location update transmission response comprising a redirect message that indicates a second base station; and
transmitting a second location update transmission from the mobile station to the second base station.

17. The method of claim 16, wherein the redirect message comprises a center frequency and an offset frequency.

18. The method of claim 16, where the transmitting a second location update transmission is performed without entering in to a Network Re-Entry from Idle Mode operation.

19. The method of claim 16, wherein the first location update transmission is transmitted during an idle mode.

20. A wireless base station comprising:
a receiver configured to receive a location update transmission; and
a transmitter configured to transmit a location update transmission response, the location update transmission response comprising a message different from a success indication and different from a failure notification.

21. The wireless base station of claim 20, wherein the location update transmission response comprises redirection information.

22. The wireless base station of claim 20, wherein the wireless base station is a Femto base station with restricted access.

23. A wireless mobile station comprising:
a transmitter configured to transmit a first location update transmission; and
a receiver configured to receive a first location update response, the first location update response comprising information indicative of a redirection.

24. The wireless mobile station of claim 23, wherein the transmitter is further configured to transmit a second location update transmission in response to the first location update response.

25. The wireless mobile station of claim 23, wherein the transmitter is configured to transmit the first location update transmission while in idle mode.
